(19) United States
(12) Patent Application Publication
(10) Pub. No.: US 2017/0120339 A1
(43) Pub. Date: May 4, 2017

(54) NEW POWDER METAL PROCESS FOR PRODUCTION OF COMPONENTS FOR HIGH TEMPERATURE USEAGE

(71) Applicant: Metalvalue SAS, Paris (FR)

(72) Inventor: Christer ASLUND, Torshalla (SE)

(73) Assignee: Metalvalue SAS, Paris (FR)

(21) Appl. No.: 15/310,825

(22) PCT Filed: May 13, 2015
(86) PCT No.: PCT/SE2015/050541

§ 371 Date: Nov. 14, 2016

(30) Foreign Application Priority Data
May 13, 2014 (SE) 1450557-2

(51) Int. Cl. B22F 7/00; B22F 3/15; B22F 3/04; C01G 25/02; B22F 3/10; B22F 9/04; C01F 7/02; B22F 1/00; B22F 3/16

(52) U.S. Cl. CPC B22F 7/008; B22F 1/0003; B22F 3/15; B22F 3/04; B22F 3/16; B22F 3/1021; B22F 9/04; C01F 7/02; C01G 25/02; B22F 2301/35; B22F 2302/253; B22F 2998/10; C01P 2002/60; C01P 2006/34

(57) ABSTRACT

There is provided a method for the manufacture of a metal part from powder comprising the steps: a) providing a spherical metal powder, b) mixing the powder with a hydrocolloid in water to obtain an agglomerated metal powder, c) compacting the agglomerated metal powder to obtain a part of compacted agglomerated metal powder, wherein the structure of the part is open, d) debinding the part to remove the hydrocolloid, e) compacting the part using high velocity compaction (HVC) preferably to a density of more than 95% of the full theoretical density, f) further compacting the part using hot isostatic pressing (HIP) preferably to more than 99% of the full theoretical density to obtain a finished metal part, wherein at least one oxide is added to the metal powder before step c), which oxide has a melting point higher than the melting point of the metal powder.

### TECHNICAL FIELD

The present invention relates generally to a method for manufacturing metal parts with improved high temperature properties.

### BACKGROUND

It is well known that fully dense PM (powder metal) products made from gas atomized steels exhibit in many cases an excellent behavior in demanding environments also at high temperatures.

It is also well known that, due to the so called “Zener Brake” phenomena which is an effect of fine dispersed particles, for example oxides, fully dense PM parts produced from gas atomized powders and consolidated for example through Hot Isostatic Pressing, HIP exhibits good creep properties especially at lower temperatures in the creep range compared with conventionally wrought steel. However at higher creep temperatures they usually exhibit worse properties. This is due to the effect of the above Zener brake effect which gives good creep stability but also gives usually a finer grain size on the component. It is well known that at higher creep temperatures a bigger grain size is required to give an optimal high creep rupture strength of the component.

There are techniques to control the grain size with above PM steels for example through wet milling of powders combined with pre-annealing at different temperatures before consolidation or for example by Hot Isostatic Pressing. All these techniques are shown to be very costly and time consuming. It has also shown that it is extremely difficult to control the final grain size efficiently.

### SUMMARY

It is an object of the present invention to obviate at least some of the disadvantages in the prior art and to provide an improved method to manufacture metal parts as well as metal parts.

In a first aspect there is provided a method for the manufacture of a metal part from powder comprising the steps: a) providing a spherical metal powder, b) mixing the powder with a hydrocolloid in water to obtain an agglomerated metal powder, c) compacting the agglomerated metal powder to obtain a part of compacted agglomerated metal powder, wherein the structure of the part is open, d) debinding the part to remove the hydrocolloid, e) compacting the part using high velocity compaction (HVC) preferably to a density of more than 95% of the full theoretical density, f) further compacting the part using hot isostatic pressing (HIP) preferably to more than 99% of the full theoretical density to obtain a finished metal part, wherein at least one oxide is added to the metal powder before step c), which oxide has a melting point higher than the melting point of the metal powder.

In a second aspect there is provided a metal part comprising an oxide and which is manufactured according to any embodiment of the method described above.

Further aspects and embodiments are defined in the appended claims, which are specifically incorporated herein by reference.

It is disclosed that it is possible to combine the ZenerBrake effect with a controlled addition of small oxides and this gives new options and applications for the PM produced fully dense products made from gas atomized powders.

There is described a new process where a process is combined with special control of ingoing powder sizes and addition of fine particles of oxides such as for instance Alumina (Al₂O₃) and/or Zirconium oxide and it gives precise final grain sizes in the final component. The components exhibit also, due to the ZenerBrake effect, high resistance against grain growth at for example welding but also better erosion properties.

Grain boundaries disrupt the motion of dislocations through a material. Dislocation propagation is impeded because of the stress field of the grain boundary defect region and the lack of slip planes and slip directions and overall alignment across the boundaries. Reducing grain size is therefore a common way to improve strength, often without any sacrifice in toughness because the smaller grains create more obstacles per unit area of slip plane. This crystallite size-strength relationship is given by the Hall-Petch relationship.

Grain boundary migration plays an important role in many of the mechanisms of creep. Grain boundary migration occurs when a shear stress acts on the grain boundary plane and causes the grains to slide. This means that fine-grained materials actually have a poor resistance to creep relative to coarser grains, especially at high temperatures, because smaller grains contain more atoms in grain boundary sites. Grain boundaries also cause deformation in that they are sources and sinks of point defects. Voids in a material tend to gather in a grain boundary, and if this happens to a critical extent, the material could fracture.

During grain boundary migration, the rate determining step depends on the angle between two adjacent grains. In a small angle dislocation boundary, the migration rate depends on vacancy diffusion between dislocations. In a high angle dislocation boundary, this depends on the atom transport by single atom jumps from the shrinking to the growing grains.

It is known that for stainless steel the creep properties depends very much of the grain size. At low temperature a fine grain size gives improved creep properties while at higher temperatures a more coarse grain size is desired to give optimum creep properties. In many cases it is a prerequisite that the material used at a certain creep range has a specified min. grain size.

There is described a way to overcome the difficulty with control of grain size in PM fully dense steel and alloys by using a process where metal powder is agglomerated with a binder in water.

The final grain size can be determined by using fine particles of stable oxides which are added during agglomeration. By using a determined starting grain size or fraction size very determined final grain sizes can be achieved.

By this effect more cost efficient alloys and steels could be produced for high temperature usage. Candidates are ferritic chromium steels which have an excellent oxidation resistance but in normal conditions suffer from very low creep resistance.

The addition of oxides as above can lead to improvements in the following areas:
Limited grain growth also at high temperatures
Improved creep properties when using components at high temperatures especially when subjected to stresses.
Better erosion resistance in operation, for example in sliding contacts or when fluids or gases with aggressive particles are exposed to components, especially at higher temperatures.

### BRIEF DESCRIPTION OF THE DRAWINGS

The invention is now described, by way of example, with reference to the accompanying drawings, in which:

FIG. 1 shows grain size vs temperature for different materials,

FIG. 2 shows different routes to obtain a steel part from powder,

FIG. 3 shows the structure of a sample, and

FIG. 4 shows the results of a creep test for a sample.

### DETAILED DESCRIPTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

In a first aspect there is provided a method for the manufacture of a metal part from powder comprising the steps: a) providing a spherical metal powder, b) mixing the powder with a hydrocolloid in water to obtain an agglomerated metal powder, c) compacting the agglomerated metal powder to obtain a part of compacted agglomerated metal powder, wherein the structure of the part is open, d) debinding the part to remove the hydrocolloid, e) compacting the part using high velocity compaction (HVC) preferably to a density of more than 95% of the full theoretical density, f) further compacting the part using hot isostatic pressing (HIP) preferably to more than 99% of the full theoretical density to obtain a finished metal part, wherein at least one oxide is added to the metal powder before step c), which oxide has a melting point higher than the melting point of the metal powder.

Spherical metal powder means that almost all of the metal particles in the powder are essentially shaped as spheres. Although the process can be carried out also with non-spherical metal powders the result is better with spherical metal powders.

In one embodiment the oxide has a melting point at least 100° C. higher than the metal powder. In one embodiment the oxide has a melting point at least 200° C. higher than the metal powder. In one embodiment the oxide has a melting point at least 300° C. higher than the metal powder.

In one embodiment the metal is steel. In one embodiment the metal is stainless steel.

In one embodiment the oxide is a metal oxide. In one embodiment the oxide is at least one selected from the group consisting of aluminum oxide and zirconium oxide.

In one embodiment the oxide is the form of a powder with an average grain size smaller than 0.2 μm. In one embodiment the oxide is the form of a powder with an average grain size smaller than 0.3 μm. In one embodiment the oxide is the form of a powder with an average grain size smaller than 0.5 μm. In one embodiment the oxide is the form of a powder with an average grain size smaller than 0.7 μm. In one embodiment the oxide is the form of a powder with an average grain size smaller than 1.0 μm. The grain size is measured as the largest size in any dimension for a particle of random shape. The average size is calculated as the number average for all particles. Thus in one embodiment with an average grain size smaller than 0.3 μm, a few particles could have a size exceeding 0.3 μm while the remaining particles have sizes below 0.3 μm so that the average is below 0.3 μm.

In one embodiment the oxide is mixed together with the powder and the hydrocolloid in water in step b) to obtain the agglomerated metal powder.

In step c) the first compacting can be performed by any method giving an open structure so that the binder can be removed in a subsequent debinding/delubricating step. After such a first compacting step the density should normally be below 90% of the full theoretical density to give an open structure permitting transport of the hydrocolloid out of the part when the part is heated.

In one embodiment the finished metal part obtains a density exceeding 99.5% of the full theoretical density after step f). In one embodiment the finished metal part obtains a density exceeding 99.0% of the full theoretical density after step f). The HIP in step f) is in one embodiment performed without any capsule and in an alternative embodiment with a capsule.

In one embodiment the part is treated in at least one step between steps e) and f), examples of such treatment include but is not limited to heating, sintering, and re-striking with HVC. In one embodiment the treatment is heating.

Polycrystalline materials are solids that are composed of many crystallites of varying size and orientation. Crystallites are also referred to as grains. They are small or even microscopic crystals and form during the cooling of the material. In one embodiment the grain size in the spherical metal powder provided in step a) is selected in order to control the grain size in the finished product. For instance a desired coarse grain size can be obtained in the finished product by starting with a coarse grain size in the spherical metal powder. This is particularly desirable for materials to be used at high temperatures.

In a second aspect there is provided a metal part comprising an oxide and which is manufactured according to any embodiment of the method described above.

A compulsory step in the process is the use of the HVC compaction step in order to reach a density high enough to permit capsule free HIP for final consolidation. It seems also clear that due to the fine dispersion of the fine added particles on the spherical grains the structure is ductile enough to be able to subject the deformations in the HVC step.

It is known generally, for example for stainless steel that the creep properties are improved at lower temperatures in the creep range with finer grain size while at higher creep temperatures a more coarse grain size gives better creep properties than a fine grain size.

The test material selected was stainless steel 316 L. This alloy is also used in creep applications and often it is required that the material has a minimum grain size to exhibit best creep properties.

The analysis shows oxygen content of approximately 125 PPM. Even at this low level of oxides, mostly Manganese-, Aluminium- and other alloys with high melting point, the levels AND morphology is enough to influence strongly the grain growth at high temperatures. Normal wrought steel has an oxygen content correctly processed of say 30-70 PPM. In the present process the oxygen content is preferably reduced (if correct low dew point is used!) and the difference is really marginal regarding the oxygen content.

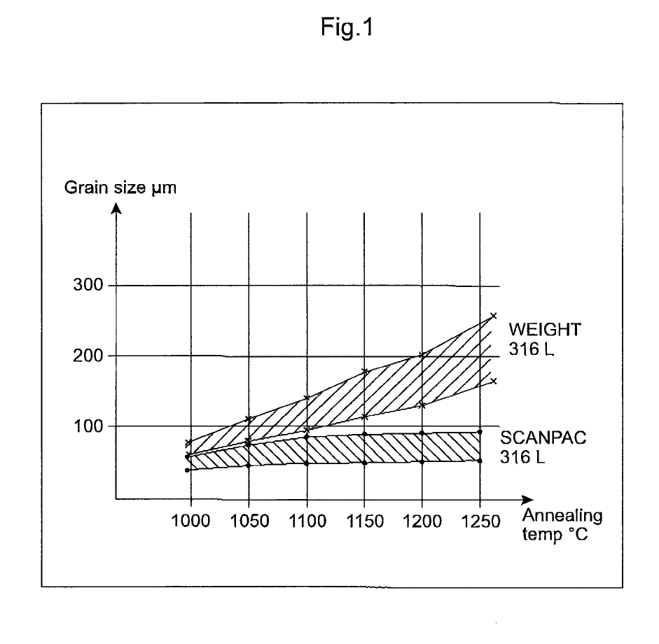

We subjected a piece of 316 L manufactured according to the present invention as well as a conventional wrought steel part with same analysis to a heat treatment, see FIG. 1. It is remarkable to see the difference. The material according to the present invention had still at 1300° C. a grain size of around ASTM 4-5 while the conventional part showed strong grain growth. The oxygen content of the conventional material was 45 PPM.

The reason for this difference is the number of and different sizes of the oxides. The Zener Brake formula says that the finer the oxides, the more stable is the Zener Brake structure. In the formula below f=number of parts i.e. fraction size.

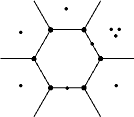

If you compare the oxides, the PM oxides (i.e. the oxides already present in the metal powder) are very small, generally under 1 micron in size. The fact that they in numbers also at same oxygen content are more gives also according to the formula this effect.

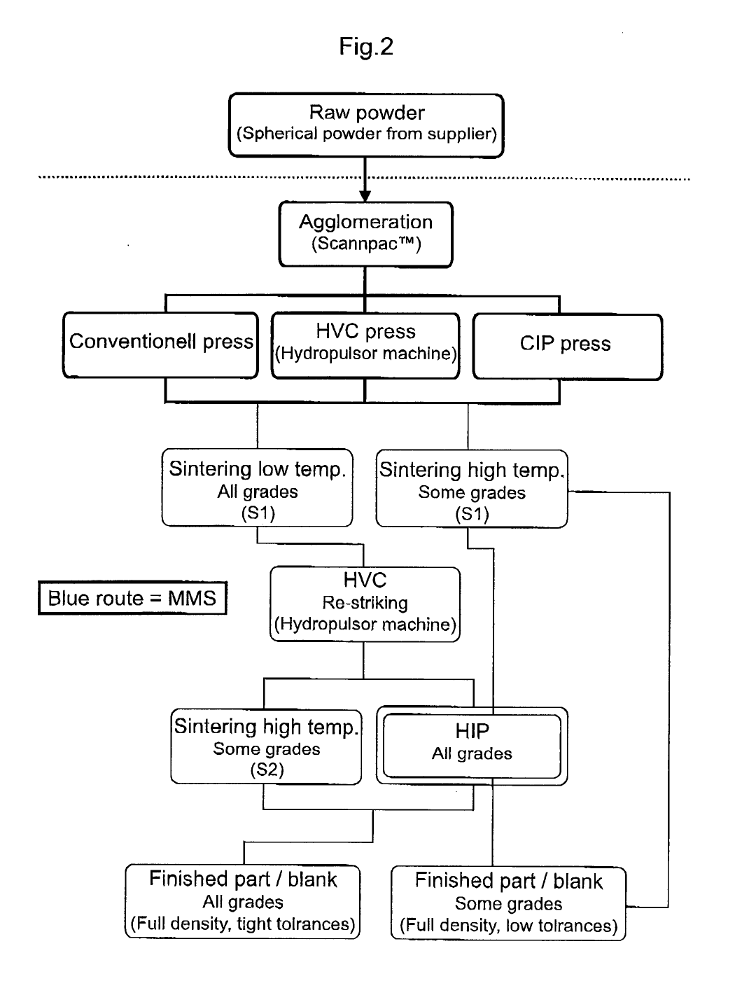

The normal route for 316 L is shown in FIG. 2. Observe that we talk about “normal grain size” in the agglomerated spherical powder, typically 150-300 μm initial grain size compared to the MIM process where the grain size is usually −22 μm. The key element is the compaction step HVC where you drive the density before final densification to min. 95% of T.D. usually for 316 L as high as 97% T.D.

The final sintering in hydrogen is usually done at 1360-1385° C. in pure hydrogen. The density is then well over 99% of T.D. As an alternative to final sintering capsule free HIP can be made as at say 1150° C. resulting in principally full density.

316 L material according to the present invention has been tested regarding creep properties at 600° C. which is the under limit for the creep range. Here the creep properties are usually better than conventional material, probably due to a combined effect of fine grain size and the dispersing effect of the fine oxides. However at higher creep temperatures the conventional 316 L has better creep properties because it is relatively easy to get a bigger grain size which gives this effect. The material according to the invention is as shown in FIG. 1. If you manage to increase the grain size it is very uneven and unpredictable.

The present way to improve high temperature properties is to add fine oxide particles of high temperature stable oxides such as aluminum oxide and/or zirconium oxide.

It was decided to add fine Al₂O₃ powder with a grain size of <0.3 μm. The present process, which uses a water soluble binder is ideal when mixing in these fine oxides.

The following grain sizes were used for the metal powder;

0-150 μm

0-22 μm

0-75 μm

150-250 μm

250-500 μm.

The grain size is measured before agglomeration of the metal powder.

To each of these grain sizes an addition of fine Al₂O₃ powder (<0.3 μm) was added during agglomeration. Two amounts of aluminium oxide were added, 0.5 weight % and 1 weight % for each grain size. Due to the technique at agglomeration the present agglomeration technique makes it easy to add this type of fine particulates. Due to the fineness of the oxides, the fine particles are wetting the surfaces of the powder particles, even the finest.

Compacts of each mixture set up were produced according to FIG. 2. The final densification was done with sintering at high temperature, 1385° C. Normally you get a complete densification for 316 L going from approximately 96% density after High Velocity Compaction, HVC, to +99.5% T.D. by sintering at this high temperature.

However in this case no effect of sintering was detected. The components were in practice unchanged in spite of the high sintering temperature. This effect is of course a result of the blocking effect of the fine oxide particles. As the particles were even distributed on the surfaces of the original powder particles, in principle the original powder grains were seen and detectable.

It was therefore decided to make a new approach. In each step the parameters were optimized inclusive that at final HVC compaction step the part was preheated to 200° C. The resulting part after HVC was measured to 97.2% T.D.

At this density level the components show closed porosity. However a fast sintering was made at 1385° C. to assure full closure of the structure.

After this the parts were subjected to a capsule free HIP cycle at 1150° C. The density after this operation was in principle 100% density measured by Archimedes and microscope.

When the grain sizes and structures were measured it was found that for each of above fraction size the grain sizes reflected the starting size of the original powder fractions, see table below.

| | | FINAL | |
|---|---|---|---|
| | POWDER GRAIN | COMPONENT | |
| TYPE OF | SIZE | GRAIN SIZE | |
| FRACTION | μm | ASTM | REMARKS |
| a) | 0-150 | <5 | Very big variation |
| b) | 0-22 | 9 | Very even grain |
| | | | size |
| c) | 0-75 | 5 | Even grain size |
| d) | 150-250 | 3 | ″ |
| e) | 250-500 | 1-2 | ″ |

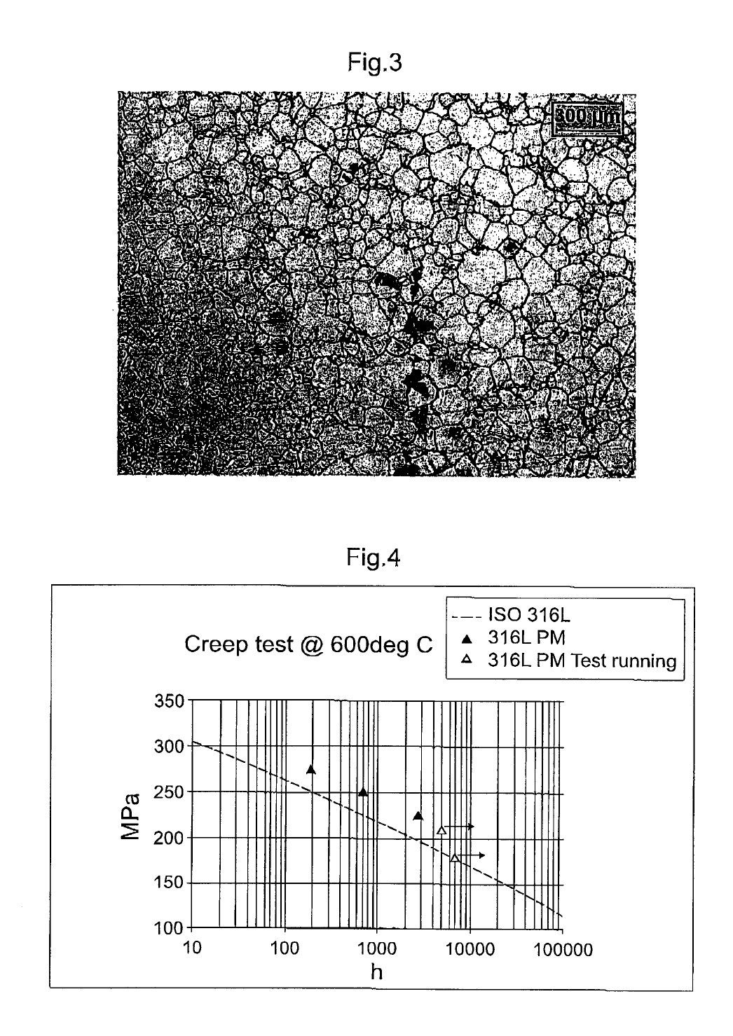

The structure of fraction a) after the present process is shown in FIG. 3.

The above components were subjected to an annealing test at 1385° C. In principle the structures were unchanged regarding grain size. At same time conventional material treated same showed excessive grain growth with measured grain sizes of ASTM 0 and even ASTM 00.

It seems clear that with additions of stable oxides like aluminum oxide and/or zirconium oxide the final grain size can be controlled very detailed with above described process.

If comparing the present 316L and conventional produced 316 L at same grain size you can measure a better performance for the present components at low creep temperatures, see FIG. 4. This is due to the effect of existing normal volumes of oxides which, contrary to conventional material, always are present in small sizes, many under 1 μm in diameter. In other words gives the Zener Brake also this effect mentioned above. Due to this effect it was also difficult to anneal in a controlled way this type of material to a coarser grain size which is wanted at high creep temperatures.

A hydrocolloid is defined as a colloid system wherein the colloid particles are hydrophilic polymers dispersed in water. In one embodiment the colloid is a thermo-reversible hydrocolloid. An example of a hydrophilic polymers in the present invention includes but is not limited to gelatine. In one embodiment the amount of binder in the agglomerated metal powder does not exceed 1.5% by weight.

Other features and uses of the invention and their associated advantages will be evident to a person skilled in the art upon reading the description and the examples.

It is to be understood that this invention is not limited to the particular embodiments shown here. The embodiments are provided for illustrative purposes and are not intended to limit the scope of the invention since the scope of the present invention is limited only by the appended claims and equivalents thereof.

1. A method for the manufacture of a metal part from spherical metal powder comprising the steps:
a. providing a spherical metal powder,
b. mixing the spherical powder with a hydrocolloid in water to obtain an agglomerated spherical metal powder,
c. compacting the agglomerated spherical metal to obtain a part of compacted agglomerated metal powder, wherein the structure of the part is open,
d. debinding the part to remove the hydrocolloid,
e. compacting the part using high velocity compaction (HVC) preferably to a density of more than 95% of the full theoretical density,
f. further compacting the part using HIP, preferably to more than 99% of the full theoretical density, to obtain a finished metal part,
wherein at least one oxide is added to the metal powder before step c), which oxide has a melting point higher than the melting point of the metal powder.

2. The method according to claim 1, wherein the oxide has a melting point at least 100° C. higher than the metal powder, wherein the oxide is stable at the melting point of the metal powder, and wherein the oxide does not react with the metal powder at the melting point of the metal powder.

3. The method according to claim 1, wherein the metal is steel.

4. The method according to claim 1, wherein the metal is stainless steel.

5. The method according to claim 1, wherein the oxide is a metal oxide.

6. The method according to claim 1, wherein the oxide is at least one selected from the group consisting of aluminium oxide and zirconium oxide.

7. The method according to claim 1, wherein the oxide is the form of a powder with an average grain size smaller than 1 μm.

8. The method according to claim 1, wherein the oxide is mixed together with the powder and the hydrocolloid in water in step b) to obtain the agglomerated metal powder.

9. The method according to claim 1, wherein the part is treated in at least one additional step between steps e) and f).

10. The method according to claim 1, wherein the grain size in the spherical metal powder provided in step a) is selected in order to control the grain size in the finished product.

11. A metal part comprising an oxide and which is manufactured according to claim 1.
